(19) United States
(12) Patent Application Publication
(10) Pub. No.: US 2024/0262346 A1
(43) Pub. Date: Aug. 8, 2024

(54) SYSTEM FOR WITHHOLDING BASIC SAFETY MESSAGES BASED ON TRANSMITTED MANEUVER MESSAGES

(71) Applicant: TOYOTA MOTOR ENGINEERING & MANUFACTURING NORTH AMERICA, INC., PLANO, TX (US)

(72) Inventors: SERGEI S. AVEDISOV, Mountain View, CA (US); HAO M. WANG, Mountain View, CA (US); ONUR ALTINTAS, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, Toyota-shi (JP)

(21) Appl. No.: 18/164,482

(22) Filed: Feb. 3, 2023

(51) Int. Cl. B60W 30/08

(52) U.S. Cl. CPC B60W 30/08; B60W 2510/0638; B60W 2554/4041

(57) ABSTRACT

Examples of the presently disclosed technology provide systems and methods for intelligently withholding selected basic safety messages (or other similar messages) from transmission by determining that current vehicle state-related information contained in the selected BSMs is redundant to predicted vehicle state-related information contained in a previously transmitted maneuver message (or other similar messages). Accordingly, examples of the presently disclosed technology can reduce strain on wireless communication channel resources (e.g., proximate to large traffic environments) by reducing the number of messages exchanged among connected vehicles—while preserving the traffic safety and efficiency advantages associated with such communication.

### TECHNICAL FIELD

The present disclosure relates generally to automotive systems and technologies, and more particularly, some examples relate to withholding basic safety messages (or other similar messages) from transmission.

### DESCRIPTION OF RELATED ART

Connected vehicles use wireless communication to communicate with other vehicles (sometimes referred to as vehicle-to-vehicle or V2V communication), roadside infrastructure (sometimes referred to as vehicle-to-infrastructure or V2I communication), the internet, or even pedestrians. Such wireless communication (which typically takes the form of messages sent using radio signals) can allow for better cooperation between connected vehicles (for example doing multiple maneuvers simultaneously)—which can improve traffic safety and efficiency.

### BRIEF SUMMARY OF THE DISCLOSURE

According to various examples of the disclosed technology, a method for selectively withholding basic safety messages (or other similar messages) is provided. The method may comprise: 1) transmitting a first message describing predicted states of a vehicle across a time horizon (T); 2) before transmitting a second message describing a current state of the vehicle (CSᵢ) at a time (tᵢ), determining a predicted state of the vehicle (PSᵢ) described in the first message corresponding to the time (tᵢ); 3) determining that the predicted state of the vehicle (PSᵢ) corresponding to the time (tᵢ) deviates, under a threshold amount, from the current state of the vehicle (CSᵢ) described in the second message; and 4) based on the determinations, withholding the second message from transmission. The first message may comprise a maneuver message and the second message may comprise a basic safety message. The first message may comprise a plurality of time-stamped data breadcrumbs describing the predicted states of the vehicle across the time horizon (T). In certain examples, determining the predicted state of the vehicle (PSᵢ) described in the first message corresponding to the time (tᵢ) may comprise: a) associating the time (tᵢ) with a first time-stamped data breadcrumb of the plurality of time-stamped data breadcrumbs based on the time-stamp for the first time-stamped data breadcrumb, the first time-stamped data breadcrumb describing a first predicted state of the vehicle; and b) determining the predicted state of the vehicle (PSᵢ) corresponding to the time (tᵢ) based on the first predicted state of the vehicle. In some examples the first predicted state of the vehicle and the predicted state of the vehicle (PSᵢ) corresponding to the time (tᵢ) may be the same (e.g., where the time-stamp for the first predicted state of the vehicle corresponds to the same/similar clock time as the time (tᵢ)). In other examples the first predicted state of the vehicle and the predicted state of the vehicle (PSᵢ) corresponding to the time (tᵢ) may be different (e.g., where the time-stamp for the first predicted state of the vehicle corresponds to a different clock time than the time (tᵢ)), and determining the predicted state of the vehicle (PSᵢ) corresponding to the time (tᵢ) based on the first predicted state of the vehicle may comprise interpolating the predicted state of the vehicle (PSᵢ) corresponding to the time (tᵢ) based on the first time-stamped data breadcrumb. In these examples, interpolating the predicted state of the vehicle (PSᵢ) corresponding to the time (tᵢ) based on the first time-stamped data point may comprise: i) associating the time (tᵢ) with the first time-stamped data breadcrumb and a second time-stamped data breadcrumb of the plurality of time-stamped data breadcrumbs based on the time-stamp for the first time-stamped data breadcrumb and the time-stamp for the second time-stamped data breadcrumb, the time (tᵢ) lying between the time-stamp for the first time-stamped data breadcrumb and the time-stamp for the second time-stamped data breadcrumb; and ii) interpolating the predicted state of the vehicle (PSᵢ) corresponding to the time (tᵢ) based on the first time-stamped data breadcrumb and the second time-stamped data breadcrumb.

In various examples, a vehicle capable of selectively withholding basic safety messages (or other similar messages) is provided. The vehicle may comprise an electronic control unit including machine executable instructions in non-transitory memory to: 1) transmit a first message comprising a plurality of time-stamped data breadcrumbs describing predicted states of the vehicle across a time horizon (T); 2) before transmitting a second message describing a current state of the vehicle (CSᵢ) at a time (tᵢ), associate the time (tᵢ) with a first time-stamped data breadcrumb and a second time-stamped data breadcrumb of the plurality of time-stamped data breadcrumbs, wherein the time (tᵢ) lies between the time-stamp for the first time-stamped data breadcrumb and the time-stamp for the second time-stamped data breadcrumb; 3) interpolate a predicted state of the vehicle (PSᵢ) corresponding to the time (tᵢ) based on the first time-stamped data breadcrumb and the second time-stamped data breadcrumb; 4) determine that the predicted state of the vehicle (PSᵢ) corresponding to the time (tᵢ) deviates, under a threshold amount, from the current state of the vehicle (CSᵢ) described in the second message; and 5) based on the determination, withhold the second message from transmission. The first message may comprise a maneuver message and the second message may comprise a basic safety message. The first time-stamped data breadcrumb may describe a first predicted state of the vehicle and the second time-stamped data breadcrumb may describe a second predicted state of the vehicle. Accordingly, the predicted state of the vehicle (PSᵢ) corresponding to the time (tᵢ) may comprise an intermediate predicted state of the vehicle between the first predicted state of the vehicle and the second predicted state of the vehicle. In certain examples, the predicted state of the vehicle (PSᵢ) corresponding to the time (tᵢ) may comprise at least one of a predicted position (PSP), a predicted speed (PSSᵢ), and a predicted heading (PSHᵢ) corresponding to the time (tᵢ). In these examples, determining that the predicted state of the vehicle (PSᵢ) corresponding to the time (tᵢ) deviates, under the threshold amount, from the current state of the vehicle (CSᵢ) described in the second message may comprise at least one of: a) determining that the predicted position (PSPᵢ) of the vehicle corresponding to the time (tᵢ) deviates, under a threshold position amount, from a current position of the vehicle (CSPᵢ) described in the second message; b) determining that the predicted speed of the vehicle (PSSᵢ) corresponding to the time (tᵢ) deviates, under a threshold speed amount, from a current speed of the vehicle (CSSᵢ) described in the second message; and c) determining that the predicted heading of the vehicle (PSHᵢ) corresponding to the time (tᵢ) deviates, under a threshold heading amount, from a current heading of the vehicle (CSHᵢ) described in the second message.

Other features and aspects of the disclosed technology will become apparent from the following detailed description, taken in conjunction with the accompanying drawings, which illustrate, by way of example, the features in accordance with examples of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various examples, is described in detail with reference to the following figures. The figures are provided for purposes of illustration only and merely depict examples.

FIG. 1 illustrates an example architecture for a connected vehicle capable of selectively withholding basic safety message (or other similar messages), in accordance with examples of the presently disclosed technology.

FIG. 2 illustrates an example lane change scenario in which examples of the presently disclosed technology may be implemented.

FIG. 3 illustrates the example lane change scenario from FIG. 2 at a later timestep.

FIG. 4 illustrates an example flow diagram that can be used to selectively withhold basic safety message (or other similar messages), in accordance with various examples of the presently disclosed technology.

FIG. 5 illustrates example operations that can be performed by an electronic control unit in a vehicle to selectively withhold basic safety message (or other similar messages), in accordance with various examples of the presently disclosed technology.

FIG. 6 is an example computing component that may be used to implement various features of examples described in the present disclosure, in accordance with various examples of the technology described herein.

The figures are not exhaustive and do not limit the present disclosure to the precise form disclosed.

### DETAILED DESCRIPTION

For years, basic safety messages (and other related messages such as Cooperative Awareness Messages (CAMs) used in Europe) have provided a standardized means for connected vehicles to communicate their current state (e.g., position, speed, heading, brake light status, etc.) to other connected vehicles and connected entities. Conventionally, a connected vehicle automatically transmits basic safety messages (BSMs) at a fixed, and relatively high frequency (approximately every 100 milliseconds) in order to maximize/improve traffic safety and efficiency (i.e., to ensure that nearby connected entities have accurate sub-second-by-sub-second knowledge of the connected vehicle's position, speed, heading, etc.—thereby improving traffic safety and efficiency).

More recently, maneuver messages (and other related messages such as Maneuver Sharing Coordination Messages (MSCMs), Maneuver Coordination Messages (MCMs), etc.) have been introduced that allow connected vehicles to share their predicted future states over a time horizon (e.g., predicted position, speed, heading, brake light status, etc.). A typical maneuver message (MM) includes a plurality of time-stamped data breadcrumbs describing predicted vehicle states across the time horizon. For example, a first data breadcrumb may describe a first predicted vehicle state corresponding to a first time (t₁), a second data breadcrumb may describe a second predicted vehicle state corresponding to a second time (t₂), etc. Accordingly, the MM may effectively communicate a predicted trajectory for a vehicle over the time horizon via these time-stamped data breadcrumbs.

As modern vehicles become more intelligent (e.g., through autonomous and semi-autonomous driving systems which often leverage BSM and MM messages received from other connected vehicles to make predictions) and connected, the sheer number of messages transmitted between connected vehicles will become enormous. Accordingly, a unique technological problem that has arisen out of increasing intelligence/connectivity for modern vehicles is the strain that these connected vehicles impose on wireless communication channels used for V2X communication (e.g., transmission of BSMs and MMs). For example, BSMs alone (which comprise just a single type of V2X-related message), are typically transmitted by connected vehicles at a sub-second frequency (i.e., approximately every 100 milliseconds). The frequency of these BSM (and other) transmissions can impose an enormous strain on wireless communication channel resources located proximate to heavily trafficked areas with numerous connected vehicles. This is especially a concern for environments with limited bandwidth (for example the United States under the current FCC guidelines). Accordingly, there would be tremendous value in limiting the number of messages exchanged among connected vehicles—while preserving the traffic safety and efficiency advantages associated with such communication.

Against this backdrop, examples of the presently disclosed technology provide systems and methods for intelligently withholding selected BSMs (or other similar messages) from transmission by determining that current vehicle state-related information contained in the selected BSMs (or other similar messages) is redundant to predicted vehicle state-related information contained in a previously transmitted message (e.g., an MM). In other words, examples of the presently disclosed technology can reduce strain on wireless communication channel resources (e.g., proximate to large traffic environments) by reducing the number of messages exchanged among connected vehicles—while preserving the traffic safety and efficiency advantages associated with such communication. Accordingly, examples of the presently disclosed technology provide an important technical improvement over conventional connected vehicle systems which automatically transmit BSMs (e.g., at a fixed interval approximately every 100 milliseconds) regardless of whether the vehicle-state related information contained therein is redundant to predicted vehicle state-related information contained in a previously transmitted message (as alluded to above, BSMs have conventionally been transmitted automatically at this high frequency in order to ensure that other connected vehicle/entities receive accurate, sub-second-by-sub-second vehicle state information—thereby improving/maximizing traffic safety and efficiency). In other words, examples of the presently disclosed technology provide a technical improvement over existing connected vehicle systems by achieving the same/similar traffic safety and efficiency advantages—while transmitting fewer messages, thereby reducing strain on valuable wireless communication channel resources. As alluded to above (and as will be described in greater detail below), examples are able to provide such technical improvement by injecting enhanced intelligence into the BSM transmission process.

For example, in accordance with the presently disclosed technology, before transmitting a second message (e.g., a BSM) describing a current state of a vehicle (CSᵢ) at a time (tᵢ), the vehicle may determine a predicted state of the vehicle (PSᵢ) described in a previously transmitted first message (e.g., an MM) corresponding to the time (tᵢ). As described above, the first message may comprise a plurality of time-stamped data breadcrumbs describing predicted states of the vehicle across a time horizon (T) that includes the time (tᵢ). Accordingly (and as will be described in greater detail below), determining the predicted state of the vehicle (PSᵢ) described in the first message corresponding to the time (tᵢ) will often require rapid interpolation from these time-stamped (discrete) data breadcrumbs. Upon determining the predicted state of the vehicle (PSᵢ) described in the first message corresponding to the time (tᵢ), the vehicle may determine that that the predicted state of the vehicle (PSᵢ) corresponding to the time (tᵢ) deviates, under a threshold amount, from the current state of the vehicle (CSᵢ) described in the (yet to be transmitted) second message. As alluded to above, the predicted state of the vehicle (PSᵢ) corresponding to the time (tᵢ) may comprise at least one of: 1) a predicted position (PSPᵢ); 2) a predicted speed (PSSᵢ); and 3) a predicted heading (PSHᵢ) corresponding to the time (tᵢ). Accordingly, determining that the predicted state of the vehicle (PSᵢ) corresponding to the time (tᵢ) deviates, under the threshold amount, from the current state of the vehicle (CSᵢ) described in the second message may comprise at least one of: 1) determining that the predicted position (PSPᵢ) of the vehicle corresponding to the time (tᵢ) deviates, under a threshold position deviation amount, from a current position of the vehicle (CSPᵢ) described in the second message; 2) determining that the predicted speed of the vehicle (PSSᵢ) corresponding to the time (tᵢ) deviates, under a threshold speed deviation amount, from a current speed of the vehicle (CSSᵢ) described in the second message; and 3) determining that the predicted heading of the vehicle (PSHᵢ) corresponding to the time (tᵢ) deviates, under a threshold heading deviation amount, from a current heading of the vehicle (CSHᵢ) described in the second message. Upon determining that the predicted state of the vehicle (PSᵢ) corresponding to the time (tᵢ) deviates, under the threshold amount, from the current state of the vehicle (CSᵢ) described in the second message, the vehicle can withhold the second message from transmission. In this way, the vehicle can reduce wireless communication channel traffic by reducing/eliminating transmissions (e.g., BSM transmissions) that contain vehicle state-related information closely/accurately predicted in a previously transmitted message (e.g., a maneuver message). Accordingly, the vehicle can reduce strain on limited bandwidth wireless communication channels—while preserving the traffic safety and efficiency advantages provided through the transmission of BSMs and MMs. In other words, examples of the presently disclosed technology may only eliminate redundant vehicle-state information. Where a new message contains updated, non-redundant vehicle state information, the new message may be transmitted.

As alluded to above, in many cases determining the predicted state of the vehicle (PSᵢ) described in the first message (e.g., the MM) corresponding to the time (tᵢ) will require rapid and intelligent interpolation by the vehicle. For example, before transmitting the second message (e.g., the BSM) describing the current state of the vehicle (CSᵢ) at the time (tᵢ), the vehicle may associate the time (tᵢ) with a first time-stamped data breadcrumb (describing a first predicted state of the vehicle) and a second time-stamped data breadcrumb (describing a second predicted state of the vehicle) of the previously transmitted first message. Here the time (tᵢ) may lie between the time-stamp for the first time-stamped data breadcrumb and the time-stamp for the second time-stamped data breadcrumb. Accordingly, the vehicle may interpolate a predicted state of the vehicle (PSᵢ) corresponding to the time (tᵢ) based on the first time-stamped data breadcrumb (describing the first predicted state of the vehicle) and the second time-stamped data breadcrumb (describing the second predicted state of the vehicle). In other words, the predicted state of the vehicle (PSᵢ) corresponding to the time (tᵢ) may comprise an intermediate predicted state of the vehicle between the first predicted state of the vehicle and the second predicted state of the vehicle. Upon interpolating the predicted state of the vehicle (PSᵢ) corresponding to the time (tᵢ), the vehicle may determine that the predicted state of the vehicle (PSᵢ) corresponding to the time (tᵢ) deviates, under a threshold amount, from the current state of the vehicle (CSᵢ) described in the second message, and withhold the second message from transmission.

Here it should be understood that in order to effectively and selectively withhold BSMs (or other similar messages) containing redundant vehicle state-related information, vehicles of presently disclosed technology must rapidly and continuously perform the above described interpolations/determinations at a mass scale. As alluded to above, this is because in conventional connected vehicles, BSMs are automatically transmitted at a fixed interval of approximately every 100 milliseconds. Moreover, in order to reduce delays in BSM transmissions (such transmission delays could result in other connected vehicles receiving delayed/“stale” vehicle state information), vehicles of the presently disclosed technology must make the above described interpolations/determinations rapidly/almost instantaneously. Accordingly, vehicles of presently disclosed technology must rapidly and continuously perform the above described interpolations/determinations for prospective BSM messages many times per second. Relatedly, vehicles of the presently disclosed technology provide an important technical improvement over existing connected vehicle systems which automatically transmit BSMs (e.g., every 100 milliseconds) regardless of whether the vehicle-state related information contained therein is redundant to predicted vehicle state-related information contained in a previously transmitted message (e.g., an MM). In other words, vehicles of the presently disclosed technology provide a technical improvement over existing connected vehicle systems by achieving the same/similar traffic safety and efficiency advantages—while transmitting fewer messages, thereby reducing strain on valuable wireless communication channel resources.

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well (e.g., electric vehicles, hybrid vehicles, gasoline and diesel powered vehicles, etc.).

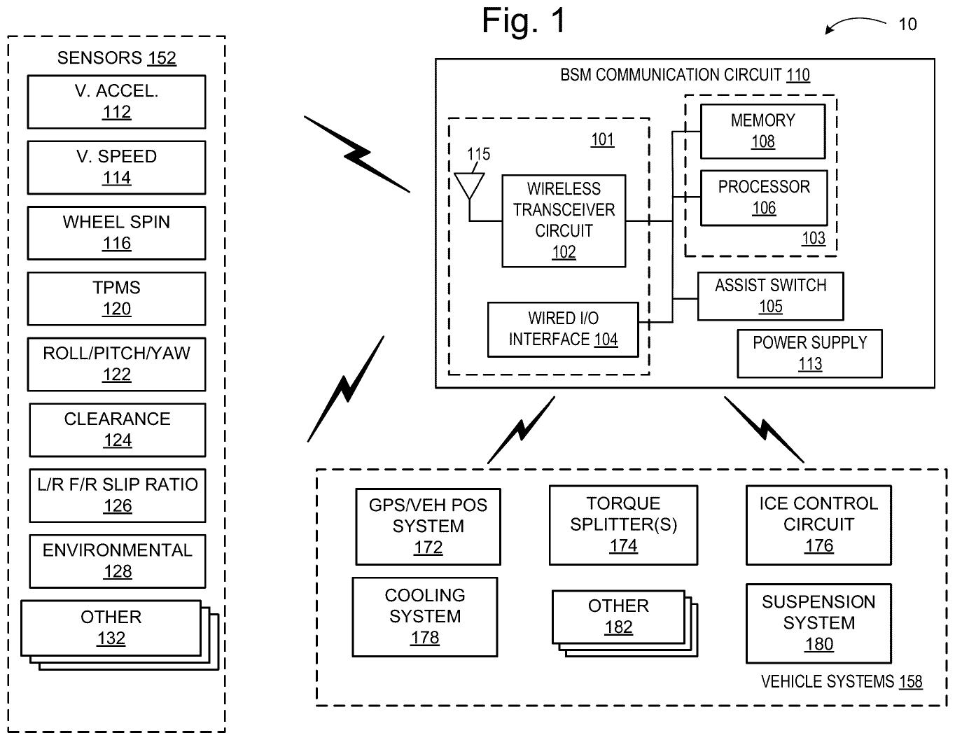

FIG. 1 illustrates an example architecture for a connected vehicle 10 capable of selectively withholding BSMs, in accordance with examples of the presently disclosed technology.

As depicted, connected vehicle 10 includes a BSM communication circuit 110, a plurality of sensors 152, and a plurality of vehicle systems 158. Sensors 152 and vehicle systems 158 can communicate with BSM communication circuit 110 via a wired or wireless communication interface. Although sensors 152 and vehicle systems 158 are depicted as communicating with BSM communication circuit 110, they can also communicate with each other as well as with other vehicle systems. BSM communication circuit 110 can be implemented as an electronic control unit (ECU) or as part of an ECU. In other examples, BSM withholding 110 can be implemented independently of an ECU.

BSM communication circuit 110 in this example includes a communication circuit 101, a decision circuit (including a processor 106 and memory 108 in this example) and a power supply 113. Components of BSM communication circuit 110 are illustrated as communicating with each other via a data bus, although other communication in interfaces can be included. BSM communication circuit 110 in this example also includes a manual assist switch 105 that can be operated by the user to manually select the BSM withholding mode.

Processor 106 can include a GPU, CPU, microprocessor, or any other suitable processing system. The memory 108 may include one or more various forms of memory or data storage (e.g., flash, RAM, etc.) that may be used to store the calibration parameters, images (analysis or historic), point parameters, instructions and variables for processor 106 as well as any other suitable information. Memory 108, can be made up of one or more modules of one or more different types of memory, and may be configured to store data and other information as well as operational instructions that may be used by the processor 106 to BSM withholding circuit 110. Memory 108 may also be used to store information related to previous MMs (or other similar predictive messages) sent by BSM communication circuit 110.

Although the example of FIG. 1 is illustrated using processor and memory circuitry, as described below with reference to circuits disclosed herein, decision circuit 103 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a BSM communication circuit 110.

Communication circuit 101 may include either or both a wireless transceiver circuit 102 with an associated antenna 115 and a wired I/O interface 104 with an associated hardwired data port (not illustrated). As this example illustrates, communications with BSM communication circuit 110 can include either or both wired and wireless communications circuits 101. Wireless transceiver circuit 102 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 115 is coupled to wireless transceiver circuit 102 and is used by wireless transceiver circuit 102 to transmit radio signals wirelessly to wireless equipment with which it is connected and to receive radio signals as well. These RF signals can include information of almost any sort that is sent or received by BSM communication circuit 110 to/from other connected entities. As alluded to above, BSM communication circuit 110 can use wireless transceiver circuit 102 to communicate with other connected vehicles (i.e., V2V communication) and connected infrastructure (i.e., V2I communication) (collectively “V2X communication”) in order to exchange traffic-related and other information. Such communication may include the transmission and receipt of BSMs, MMs and other similar messages.

Wired I/O interface 104 can include a transmitter and a receiver (not shown) for hardwired communications with other devices. For example, wired I/O interface 104 can provide a hardwired interface to other components, including sensors 152 and vehicle systems 158. Wired I/O interface 104 can communicate with other devices using Ethernet or any of a number of other wired communication protocols whether standardized, proprietary, open, point-to-point, networked or otherwise.

Power supply 113 can include one or more of a battery or batteries (such as, e.g., Li-ion, Li-Polymer, NiMH, NiCd, NiZn, and NiH₂, to name a few, whether rechargeable or primary batteries,), a power connector (e.g., to connect to vehicle supplied power, etc.), an energy harvester (e.g., solar cells, piezoelectric system, etc.), or it can include any other suitable power supply.

As alluded to above, BSM communication circuit 110 receives information from a plurality of sensors 152 located on vehicle 10. For example, BSM communication circuit 110 may receive signals that indicate vehicle state/operating conditions (e.g., vehicle position, vehicle speed, vehicle heading, brake light operation, etc.) or characteristics, or signals that can be used to derive vehicle state/operating conditions or characteristics. These may include, but are not limited to vehicle acceleration sensors 112, vehicle speed sensors 114, wheelspin sensors 116 (e.g., one for each wheel), a tire pressure monitoring system (TPMS) 120, accelerometers such as a 3-axis accelerometer 122 to detect roll, pitch and yaw of the vehicle, vehicle clearance sensors 124, left-right and front-rear slip ratio sensors 126, and environmental sensors 128 (e.g., to detect salinity or other environmental conditions). Additional sensors 132 can also be included as may be appropriate for a given implementation of BSM communication circuit 110 such as sensors for detecting operation of brake lights or turning signals on connected vehicle 10. As alluded to above, BSM communication circuit 110 can use information derived from sensors 152 to determine a current state of connected vehicle 10 and/or predicted states for connected vehicle 10.

In certain examples, one or more of the sensors 152 may include their own processing capability to compute the results for additional information that can be provided to BSM communication circuit 110. In other examples, one or more sensors may be data-gathering-only sensors that provide only raw data to BSM communication circuit 110. In further examples, hybrid sensors may be included that provide a combination of raw data and processed data to BSM communication circuit 110. Sensors 152 may provide an analog output or a digital output.

Vehicle systems 158 can include any of a number of different vehicle components or subsystems used to control or monitor various aspects of the vehicle and its performance. In this example, the vehicle systems 158 include a GPS or other vehicle positioning system 172 which can be used for determining current and predicted positions/locations and headings for the vehicle; torque splitters 174 for controlling distribution of power among the vehicle wheels such as, for example, by controlling front/rear and left/right torque split; engine control circuits 176 to control the operation of an engine (e.g. an internal combustion engine); cooling systems 178 to provide cooling for the motors, power electronics, the engine, or other vehicle systems; suspension system 180 such as, for example, an adjustable-height air suspension system, and other vehicle systems.

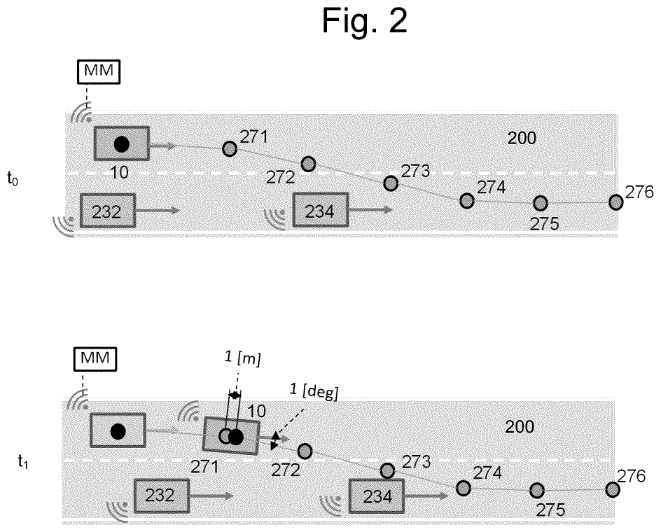

FIG. 2 illustrates an example lane change scenario in which examples of the presently disclosed technology may be implemented.

FIG. 2 includes two diagrams: 1) a top diagram depicting three vehicles on a road segment 200 at a time (t₀); and 2) a bottom diagram depicting the three vehicles on the road segment 200 at a later time (t₁). The three vehicles include connected vehicle 10 (which may be the same connected vehicle 10 as described in conjunction with FIG. 1); vehicle 232 (which may be a connected vehicle although this need not be the case); and vehicle 234 (which also may be a connected vehicle although this need not be the case).

As depicted, connected vehicle 10 transmits an MM at the time (t₀). This MM may be received by other connected vehicles in connected vehicle 10's proximity (e.g., vehicles 232 and 234), connected pieces of infrastructure located proximate to road segment 200 (not pictured), etc. As depicted, the MM may describe predicted vehicle states (e.g., predicted locations, speeds, and headings) for connected vehicle 10 across a time horizon (T). In particular, the MM may comprise a plurality of time-stamped data breadcrumbs that describe predicted vehicle states at their respective time-stamps. For example (and as depicted), the MM may describe: 1) a predicted vehicle state 271 corresponding to the time (t₁)—the dot associated with the predicted vehicle state 271 representing a predicted GPS location for connected vehicle 10 at the time (t₁); 2) a predicted vehicle state 272 corresponding to a time (t₂)—the dot associated with the predicted vehicle state 272 representing a predicted GPS location for connected vehicle 10 at the time (t₂); 3) a predicted vehicle state 273 corresponding to a time (t₃)—the dot associated with the predicted vehicle state 273 representing a predicted GPS location for connected vehicle 10 at the time at the time (t₃); etc. As alluded to above (and as depicted), a predicted trajectory for connected vehicle 10 may be interpolated from these time-stamped data breadcrumbs/vehicle states. As depicted, the predicted trajectory for connected vehicle 10 includes a lane change where connected vehicle 10 merges in front of vehicle 234.

As alluded to above, in accordance with examples of the presently disclosed technology, connected vehicle 10 may intentionally (and intelligently) withhold transmission of a BSM containing current vehicle state information that was accurately/closely predicted in a previously transmitted MM. For example, before transmitting a BSM at the time (t₁), connected vehicle 10 may first determine a predicted state for connected vehicle 10 described in the MM corresponding to the time (t₁). In the simplified example of FIG. 2, the predicted state that corresponds to the time (t₁) is predicted vehicle state 271 (for simplicity, in the example of FIG. 2 it is assumed that connected vehicle 10 transmits BSMs at clock times corresponding to the time-stamps of the time-stamped data breadcrumbs of the MM—i.e., that connected vehicle 10 transmits BSMs at times (t₁), (t₂), (t₃), etc.—however in many cases this will not be the case and interpolation will be required to determine a predicted state for connected vehicle 10 described in the MM corresponding to a time (tᵢ)). Accordingly, connected vehicle 10 may then determine whether the predicted vehicle state 271 corresponding to the time (t₁) deviates, under a threshold amount, from a current vehicle state described in the BSM to be transmitted at the time (t₁).

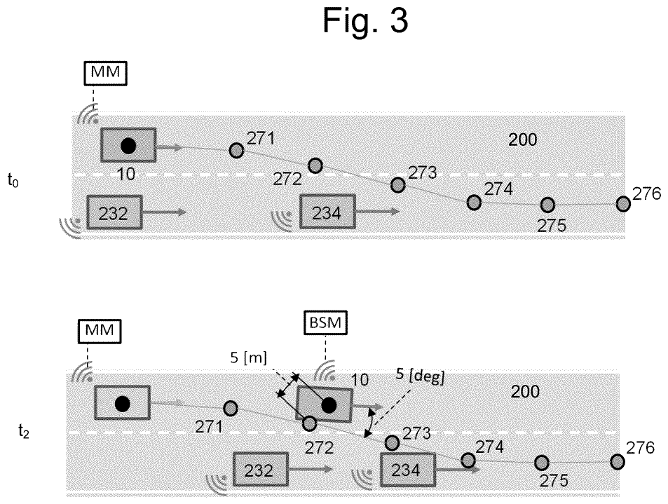

As alluded to above, the predicted vehicle state 271 corresponding to the time (t₁) may comprise at least one of: 1) a predicted position 271(a); 2) a predicted speed 271(b); and 3) a predicted heading 271(c) corresponding to the time (t₁). Accordingly, determining whether the predicted vehicle state 271 corresponding to the time (t₁) deviates, under the threshold amount, from the current vehicle state described in the BSM to be transmitted at time (t₁) may comprise at least one of: 1) determining that the predicted position 271(a) corresponding to the time (t₁) deviates, under a threshold position deviation amount, from a current position described in the BSM; 2) determining that the predicted speed 271(b) of the vehicle corresponding to the time (t₁) deviates, under a threshold speed deviation amount, from a current speed of the vehicle described in the BSM; and 3) determining that the predicted heading 271(c) of the vehicle corresponding to the time (t₁) deviates, under a threshold heading deviation amount, from a current heading of the vehicle described in the BSM. In the specific example of FIG. 2, the predicted position 271(a) for connected vehicle 10 corresponding to the time (t₁) deviates by 1 meter from the current position for connected vehicle 10 described in the BSM—which may be under the threshold position deviation amount. Relatedly, the predicted heading 271(c) for connected vehicle 10 corresponding to the time (t₁) deviates by 1 degree from the current heading for connected vehicle 10 described in the BSM—which may be under the threshold heading deviation amount. The predicted speed of the vehicle 271(b) corresponding to the time (t₁) may also deviate from the current speed of the vehicle described in the BSM under the threshold speed deviation amount. Accordingly, connected vehicle 10 may determine to withhold the BSM associated with the time (t₁) from transmission based on similar/redundant information already transmitted in the MM. Where connected vehicle 10 transmits BSMs repetitively (as is typical with existing connected vehicles), connected vehicle 10 may reevaluate whether to transmit a BSM at a later time (t₂) using the same/similar process as that described above. This situation is described in conjunction with FIG. 3.

Referring now to FIG. 3, FIG. 3 illustrates the example lane change scenario from FIG. 2 at a later timestep (t₂).

Like FIG. 2, FIG. 3 includes a top diagram depicting the three vehicles (i.e., connected vehicle 10 and vehicles 232 and 234) on the road segment 200 at the time (t₀). The bottom diagram of FIG. 3 depicts the three vehicles on the road segment 200 at the later time (t₂).

As depicted, connected vehicle 10 transmitted the MM (described in conjunction with FIG. 2) at the time (t₀). As alluded to above, before transmitting a BSM at a later time (t₂), connected vehicle 10 determines whether or not to withhold the BSM by determining whether the predicted vehicle state 272 corresponding to the time (t₂) deviates, under the threshold amount, from the current vehicle state described in the BSM associated with the time (t₂). As described above, this determination may comprise at least one of: 1) determining that a predicted position 272(a) corresponding to the time (t₂) deviates, under a threshold position deviation amount, from a current position described in the BSM associated with the time (t₂); 2) determining that the predicted speed of the vehicle 272(b) corresponding to the time (t₂) deviates, under a threshold speed deviation amount, from a current speed of the vehicle described in the BSM associated with the time (t₂); and 3) determining that the predicted heading of the vehicle 272(c) corresponding to the time (t₂) deviates, under a threshold heading deviation amount, from a current heading of the vehicle described in the BSM associated with the time (t₂). In the specific example of FIG. 3, the predicted position 272(a) for connected vehicle 10 corresponding to the time (t₂) deviates by 5 meters from the current position for connected vehicle 10 described in the BSM associated with the time (t₂)—which may exceed the threshold position deviation amount. Relatedly, the predicted heading 272(c) for connected vehicle 10 corresponding to the time (t₂) deviates by 5 degrees from the current position for connected vehicle 10 described in the BSM associated with the time (t₂)—which may exceed the threshold heading deviation amount. Accordingly, even if the predicted speed of the vehicle 272(b) corresponding to the time (t₂) deviates under the threshold speed deviation amount, connected vehicle 10 may determine to transmit the BSM at the time (t₂). This is because the predicted vehicle state 272 corresponding to the time (t₂) described in the MM less accurately/closely predicts the actual/current state of connected vehicle 10 at the time (t₂). Thus for traffic safety and efficiency purposes, other connected vehicles/infrastructure would benefit from the updated (and more accurate) vehicle state-related information contained in the BSM transmitted at the time (t₂).

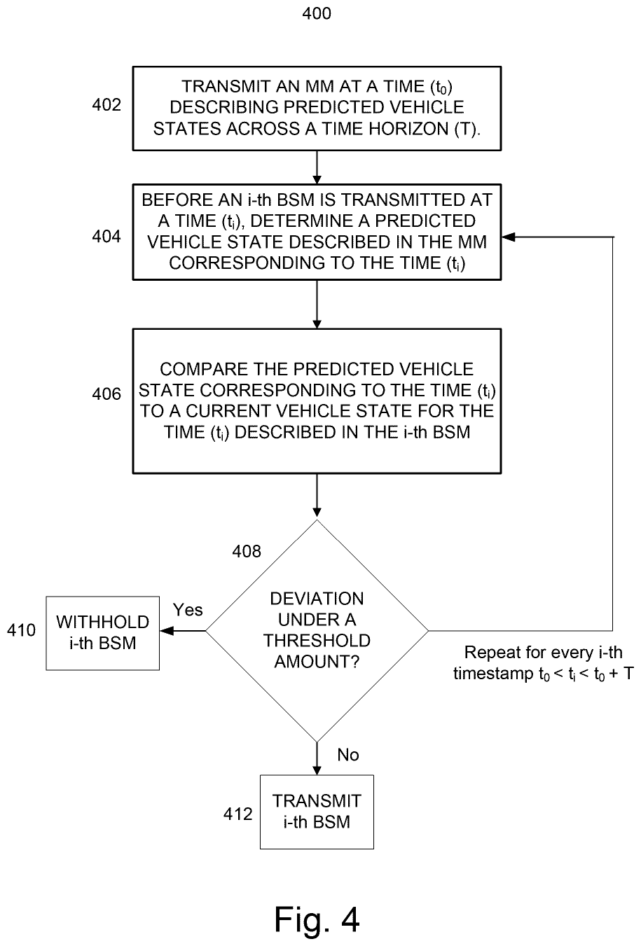

FIG. 4 illustrates an example flow diagram 400 that can be used to selectively withhold BSMs (or other similar messages), in accordance with various examples of the presently disclosed technology. In certain examples, the operations of flow diagram 400 may be performed by an ECU in a vehicle. In some of these examples, the operations may be performed by BSM communication circuit 110 described in conjunction with FIG. 1. In other examples, the operations of example flow diagram 400 may be performed by another connected entity (e.g., a connected piece of infrastructure that tracks vehicle states and transmits BSMs, MMs, and other similar messages).

Operation 402 involves transmitting an first message (e.g., and MM) at a time (t₀). The first message may describe predicted states of a vehicle across a time horizon (T). In certain examples, the first message may comprise a plurality of time-stamped data breadcrumbs describing the predicted states of the vehicle across the time horizon (T). The predicted states of the vehicle may include various types of predicted operational parameters of the vehicle including predicting positions (e.g., GPS positions), predicted speeds, predicted headings, etc.

Operation 404 involves, before transmitting an i-th BSM transmission (or other similar message/transmission relating to current vehicle states) associated with the vehicle at a time (tᵢ) (where t₀<tᵢ<t₀+T), determining a predicted state of the vehicle described in the first message corresponding to the time (tᵢ). In some examples, determining the predicted state of the vehicle described in the first message corresponding to the time (tᵢ) may comprise: 1) associating the time (tᵢ) with a first time-stamped data breadcrumb of the plurality of time-stamped data breadcrumbs based on the time-stamp for the first time-stamped data breadcrumb, the first time-stamped data breadcrumb describing a first predicted state of the vehicle; and 2) determining the predicted state of the vehicle corresponding to the time (tᵢ) based on the first predicted state of the vehicle. In some examples the first predicted state of the vehicle and the predicted state of the vehicle corresponding to the time (tᵢ) may be the same (e.g., where the time-stamp for the first predicted state of the vehicle corresponds to the same/similar clock time as the time (tᵢ)). In other examples (e.g., where the time-stamp for the first predicted state of the vehicle corresponds to a different clock time than the time (tᵢ)), determining the predicted state of the vehicle corresponding to the time (tᵢ) based on the first predicted state of the vehicle may comprise interpolating the predicted state of the vehicle corresponding to the time (tᵢ) based on the first time-stamped data breadcrumb. In these examples, interpolating the predicted state of the vehicle corresponding to the time (tᵢ) based on the first time-stamped data point may comprise: i) associating the time (tᵢ) with the first time-stamped data breadcrumb and a second time-stamped data breadcrumb of the plurality of time-stamped data breadcrumbs based on the time-stamp for the first time-stamped data breadcrumb and the time-stamp for the second time-stamped data breadcrumb, the time (tᵢ) lying between the time-stamp for the first time-stamped data breadcrumb and the time-stamp for the second time-stamped data breadcrumb; and ii) interpolating the predicted state of the vehicle corresponding to the time (tᵢ) based on the first time-stamped data breadcrumb and the second time-stamped data breadcrumb. Accordingly, in these examples the predicted state of the vehicle corresponding to the time (tᵢ) may comprise an intermediate predicted state of the vehicle between the first predicted state of the vehicle and the second predicted state of the vehicle.

Operation 406 involves comparing the predicted state of the vehicle corresponding to the time (tᵢ) to a current state of the vehicle corresponding to the time (tᵢ) described in the i-th BSM, where the predicted/current states of the vehicle comprise multiple operational parameters of the vehicle (e.g., predicted/current positions, predicted/current speeds, predicted/current headings, etc.), like operational parameters may be compared (e.g., predicted position may be compared to current position, predicted speed may be compared to current speed, predicted heading may be compared to current heading, etc.). Through these comparisons, deviations between predicted and current operational parameters of the vehicle (as described in the first message and i-th BSM respectively) may be determined. As will be described below, at operation 408 these deviations may be compared to threshold deviation values/amounts in order to determine whether to transmit or withhold the i-th BSM.

As alluded to above, operation 408 involves determining whether the predicted state of the vehicle corresponding to the time (tᵢ) deviates, under a threshold amount, from the current state of the vehicle described in the i-th BSM. As alluded to above, the i-th BSM may be withheld from transmission (at operation 410) upon a determination that the predicted state of the vehicle corresponding to the time (tᵢ) deviates, under the threshold amount, from the current state of the vehicle described in the i-th BSM. Conversely, the i-th BSM may be transmitted (at operation 412) upon a determination that the predicted state of the vehicle corresponding to the time (tᵢ) deviates, at or above the threshold amount, from the current state of the vehicle described in the i-th BSM.

In examples where the predicted and current states of the vehicle comprise multiple operational parameters of the vehicle (e.g., position, speed, and heading), the BSM may be withheld from transmission upon a determination that at least one (or in some cases all) of these operational parameters have deviations below associated threshold deviation amounts. For example, the i-th BSM may only be withheld from transmission when at least one (or in some cases all) of the position, speed, and heading deviations are below their associated threshold deviation amounts.

As depicted, the operations of flow diagram 400 may be repeated for every i-th BSM transmission between times (to) and (to +T) (i.e., i=1, 2, 3, 4, . . . where t₀<tᵢ<t₀+T). Relatedly, when a new predictive message (e.g., a new MM) is transmitted after time (t₀+T), the same process may be repeated again for the new predictive message, and so on.

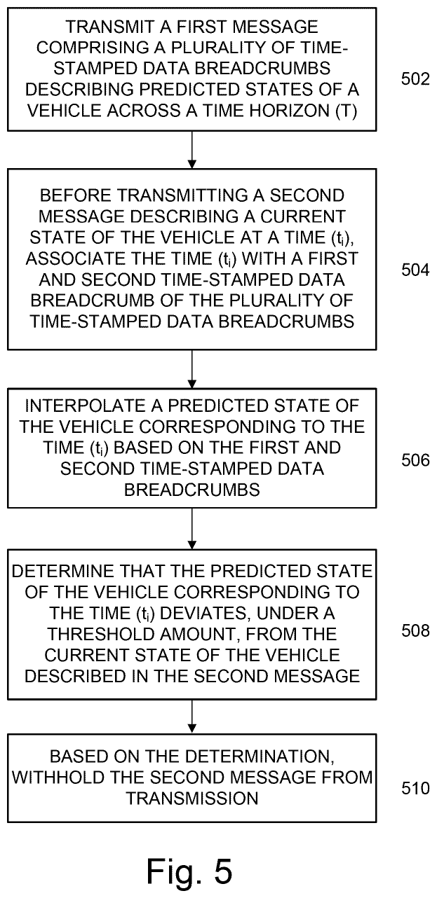

FIG. 5 illustrates example operations that can be performed by an ECU in a vehicle to selectively withhold BSMs (or other similar messages), in accordance with various examples of the technology described herein. In certain examples, these operations may be performed by BSM communication circuit 110 described in conjunction with FIG. 1. In various examples these operations may be performed dynamically.

At operation 502, the ECU transmits a first message (e.g., an MM) comprising a plurality of time-stamped data breadcrumbs describing predicted states of the vehicle across a time horizon (T). The predicted states of the vehicle may include various types of operational parameters of the vehicle including predicting positions (e.g., GPS positions), predicted speeds, predicted headings, etc.

At operation 504, before transmitting a second message (e.g., a BSM) describing a current state of the vehicle (CSᵢ) at a time (tᵢ), the ECU associates the time (tᵢ) with a first time-stamped data breadcrumb and a second time-stamped data breadcrumb of the plurality of time-stamped data breadcrumbs.

The first time-stamped data breadcrumb may describe a first predicted state of the vehicle and the second time-stamped data breadcrumb may describe a second predicted state of the vehicle.

The ECU may associate the time (tᵢ) with the first and second time-stamped data breadcrumbs because the time-stamps for the first and second time-stamped data breadcrumbs may be the closest on either side of the time (tᵢ) (i.e., before and after the time (tᵢ)). In other words, the time (tᵢ) may lie between the time-stamp for the first time-stamped data breadcrumb and the time-stamp for the second time-stamped data breadcrumb—the first and second time-stamped data breadcrumbs comprising consecutive time-stamped data breadcrumbs of the plurality of time-stamped data breadcrumbs.

At operation 506 the ECU interpolates a predicted state of the vehicle (PSᵢ) corresponding to the time (tᵢ) based on the first time-stamped data breadcrumb and the second time-stamped data breadcrumb. As alluded to above, in this situation the ECU interpolates the predicted state of the vehicle (PSᵢ) corresponding to the time (tᵢ) because the first message did not include a time-stamped data breadcrumb matching the time (tᵢ). However, through interpolation, the ECU can estimate/interpolate the predicted state of the vehicle (PSᵢ) corresponding to the time (tᵢ). In other words, the predicted state of the vehicle (PSᵢ) corresponding to the time (tᵢ) may comprise an intermediate predicted state of the vehicle between the first predicted state of the vehicle and the second predicted state of the vehicle.

At operation 508, the ECU determines whether the predicted state of the vehicle (PSᵢ) corresponding to the time (tᵢ) deviates, under a threshold amount, from the current state of the vehicle (CSᵢ) described in the second message. As alluded to above, the predicted state of the vehicle (PSᵢ) corresponding to the time (tᵢ) and the current state of the vehicle (CSᵢ) may comprise various operational parameter of the vehicle including predicting/current positions, predicted/current speeds, predicted/current headings, etc. Accordingly, determining whether the predicted state of the vehicle (PSᵢ) corresponding to the time (tᵢ) deviates, under the threshold amount, from the current state of the vehicle (CSᵢ) described in the second message may comprise at least one of: a) determining whether the predicted position (PSPᵢ) of the vehicle corresponding to the time (tᵢ) deviates, under a threshold position amount, from a current position of the vehicle (CSPᵢ) described in the second message; b) determining whether the predicted speed of the vehicle (PSSᵢ) corresponding to the time (tᵢ) deviates, under a threshold speed amount, from a current speed of the vehicle (CSSᵢ) described in the second message; and c) determining whether the predicted heading of the vehicle (PSHᵢ) corresponding to the time (tᵢ) deviates, under a threshold heading amount, from a current heading of the vehicle (CSHᵢ) described in the second message.

Based on the determination of operation 508, at operation 510 the ECU either withholds or transmits the second message. As alluded to above, the ECU withholds the second message when the ECU determines that the predicted state of the vehicle (PSᵢ) corresponding to the time (tᵢ) deviates, under the threshold amount, from the current state of the vehicle (CSᵢ) described in the second message. Conversely, the ECU transmits the second message when it determines that the predicted state of the vehicle (PSᵢ) corresponding to the time (tᵢ) deviates, at or above the threshold amount, from the current state of the vehicle (CSᵢ) described in the second message.

In examples where the predicted and current states of the vehicle comprise multiple operational parameters of the vehicle (e.g., position, speed, and heading), the ECU may only determine to withhold the second message from transmission when at least one (or in some cases all) of these operational parameters have deviations below associated threshold deviation amounts. For example, the ECU may only determine to withhold the second message from transmission when at least one (or in some cases all) of the position, speed, and heading deviations are below their associated threshold deviation amounts.

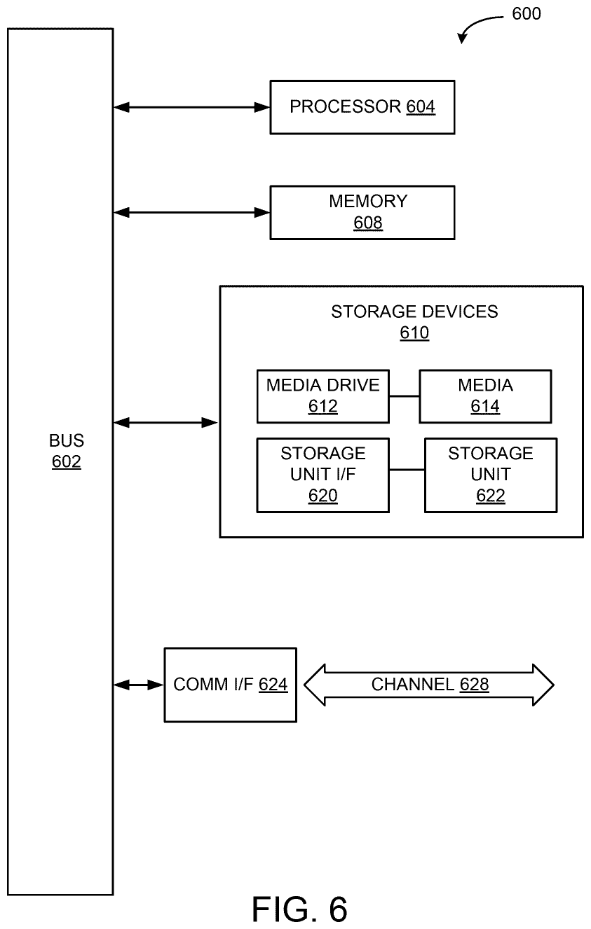

As used herein, the terms circuit and component might describe a given unit of functionality that can be performed in accordance with one or more examples of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various examples are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative examples, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual examples are not limited in their applicability to the particular example with which they are described. Instead, they can be applied, alone or in various combinations, to one or more other examples, whether or not such examples are described and whether or not such features are presented as being a part of a described example. Thus, the breadth and scope of the present application should not be limited by any of the above-described exemplary examples.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various examples set forth herein are described in terms of exemplary block diagrams, flow charts and other illustrations. As will become apparent to one of ordinary skill in the art after reading this document, the illustrated examples and their various alternatives can be implemented without confinement to the illustrated examples. For example, block diagrams and their accompanying description should not be construed as mandating a particular architecture or configuration.

What is claimed is:

1. A computer-implemented method comprising:
transmitting a first message describing predicted states of a vehicle across a time horizon (T);
before transmitting a second message describing a current state of the vehicle (CSᵢ) at a time (tᵢ), determining a predicted state of the vehicle (PSᵢ) described in the first message corresponding to the time (tᵢ);
determining that the predicted state of the vehicle (PSᵢ) corresponding to the time (tᵢ) deviates, under a threshold amount, from the current state of the vehicle (CSᵢ) described in the second message; and
based on the determinations, withholding the second message from transmission.

2. The computer-implemented method of claim 1, wherein the first message is a maneuver message and the second message is a basic safety message.

3. The computer-implemented method of claim 1, wherein the first message comprises a plurality of time-stamped data breadcrumbs describing the predicted states of the vehicle across the time horizon (T).

4. The computer-implemented method of claim 3, wherein determining the predicted state of the vehicle (PSᵢ) described in the first message corresponding to the time (tᵢ) comprises:
associating the time (tᵢ) with a first time-stamped data breadcrumb of the plurality of time-stamped data breadcrumbs based on the time-stamp for the first time-stamped data breadcrumb, the first time-stamped data breadcrumb describing a first predicted state of the vehicle; and
determining the predicted state of the vehicle (PSᵢ) corresponding to the time (tᵢ) based on the first predicted state of the vehicle.

5. The computer-implemented method of claim 4, wherein the first predicted state of the vehicle and the predicted state of the vehicle (PSᵢ) corresponding to the time (tᵢ) are the same.

6. The computer-implemented method of claim 4, wherein determining the predicted state of the vehicle (PSᵢ) corresponding to the time (tᵢ) based on the first predicted state of the vehicle comprises:
interpolating the predicted state of the vehicle (PSᵢ) corresponding to the time (tᵢ) based on the first time-stamped data breadcrumb.

7. The computer-implemented method of claim 6, wherein interpolating the predicted state of the vehicle (PSᵢ) corresponding to the time (tᵢ) based on the first time-stamped data point comprises:
associating the time (tᵢ) with the first time-stamped data breadcrumb and a second time-stamped data breadcrumb of the plurality of time-stamped data breadcrumbs based on the time-stamp for the first time-stamped data breadcrumb and the time-stamp for the second time-stamped data breadcrumb, the time (tᵢ) lying between the time-stamp for the first time-stamped data breadcrumb and the time-stamp for the second time-stamped data breadcrumb; and
interpolating the predicted state of the vehicle (PSᵢ) corresponding to the time (tᵢ) based on the first time-stamped data breadcrumb and the second time-stamped data breadcrumb.

8. The computer-implemented method of claim 1, wherein:
the predicted state of the vehicle (PSᵢ) corresponding to the time (tᵢ) comprises a predicted position (PSPᵢ), a predicted speed (PSSᵢ), and a predicted heading (PSHᵢ) corresponding to the time (tᵢ); and
determining that the predicted state of the vehicle (PSᵢ) corresponding to the time (tᵢ) deviates, under the threshold amount, from the current state of the vehicle (CSᵢ) described in the second message comprises:
determining that the predicted position (PSPᵢ) of the vehicle corresponding to the time (tᵢ) deviates, under a threshold position amount, from a current position of the vehicle (CSPᵢ) described in the second message,
determining that the predicted speed of the vehicle (PSSᵢ) corresponding to the time (tᵢ) deviates, under a threshold speed amount, from a current speed of the vehicle (CSSᵢ) described in the second message, and
determining that the predicted heading of the vehicle (PSHᵢ) corresponding to the time (tᵢ) deviates, under a threshold heading amount, from a current heading of the vehicle (CSHᵢ) described in the second message.

9. A vehicle comprising:
an electronic control unit (ECU) including machine executable instructions in non-transitory memory to:
transmit a first message comprising a plurality of time-stamped data breadcrumbs describing predicted states of the vehicle across a time horizon (T);
before transmitting a second message describing a current state of the vehicle (CSᵢ) at a time (tᵢ), associate the time (tᵢ) with a first time-stamped data breadcrumb and a second time-stamped data breadcrumb of the plurality of time-stamped data breadcrumbs, wherein the time (tᵢ) lies between the time-stamp for the first time-stamped data breadcrumb and the time-stamp for the second time-stamped data breadcrumb;
interpolate a predicted state of the vehicle (PSᵢ) corresponding to the time (tᵢ) based on the first time-stamped data breadcrumb and the second time-stamped data breadcrumb;
determine that the predicted state of the vehicle (PSᵢ) corresponding to the time (tᵢ) deviates, under a threshold amount, from the current state of the vehicle (CSᵢ) described in the second message;
based on the determination, withhold the second message from transmission.

10. The vehicle of claim 9, wherein the first message comprises a maneuver message and the second message comprises a basic safety message.

11. The vehicle of claim 9, wherein the first time-stamped data breadcrumb describes a first predicted state of the vehicle and the second time-stamped data breadcrumb describes a second predicted state of the vehicle.

12. The vehicle of claim 11, wherein the predicted state of the vehicle (PSᵢ) corresponding to the time (tᵢ) comprises an intermediate predicted state of the vehicle between the first predicted state of the vehicle and the second predicted state of the vehicle.

13. The vehicle of claim 9, wherein the predicted state of the vehicle (PSᵢ) corresponding to the time (tᵢ) comprises at least one of a predicted position (PSPᵢ), a predicted speed (PSSᵢ), and a predicted heading (PSHᵢ) corresponding to the time (tᵢ).

14. The vehicle of claim 13, wherein determining that the predicted state of the vehicle (PSᵢ) corresponding to the time (tᵢ) deviates, under the threshold amount, from the current state of the vehicle (CSᵢ) described in the second message comprises at least one of:
determining that the predicted position (PSPᵢ) of the vehicle corresponding to the time (tᵢ) deviates, under a threshold position amount, from a current position of the vehicle (CSPᵢ) described in the second message;
determining that the predicted speed of the vehicle (PSSᵢ) corresponding to the time (tᵢ) deviates, under a threshold speed amount, from a current speed of the vehicle (CSSᵢ) described in the second message; and
determining that the predicted heading of the vehicle (PSHᵢ) corresponding to the time (tᵢ) deviates, under a threshold heading amount, from a current heading of the vehicle (CSHᵢ) described in the second message.

15. A vehicle comprising:
an ECU including machine executable instructions in non-transitory memory to:
transmit a first message describing predicted states of a vehicle across a time horizon (T);
before transmitting a second message describing a current state of the vehicle (CSᵢ) at a time (tᵢ), determine a predicted state of the vehicle (PSᵢ) described in the Maneuver Message corresponding to the time (tᵢ);
determine that the predicted state of the vehicle (PSᵢ) corresponding to the time (tᵢ) deviates, under a threshold amount, from the current state of the vehicle (CSᵢ) described in the second message; and
based on the determinations, withhold the second message from transmission.

16. The vehicle of claim 15, wherein the first message comprises a maneuver message and the second message comprises a basic safety message.

17. The vehicle of claim 15, wherein the first message comprises a plurality of time-stamped data breadcrumbs describing the predicted states of the vehicle across the time horizon (T).

18. The vehicle of claim 17, wherein determining the predicted state of the vehicle (PSᵢ) described in the first message corresponding to the time (tᵢ) comprises:
associating the time (tᵢ) with a first time-stamped data breadcrumb of the plurality of time-stamped data breadcrumbs based on the time-stamp for the first time-stamped data breadcrumb, the first time-stamped data breadcrumb describing a first predicted state of the vehicle; and
determining the predicted state of the vehicle (PSᵢ) corresponding to the time (tᵢ) based on the first predicted state of the vehicle.

19. The vehicle of claim 18, wherein the first predicted state of the vehicle and the predicted state of the vehicle (PSᵢ) corresponding to the time (tᵢ) are the same.

20. The vehicle of claim 18, wherein determining the predicted state of the vehicle (PSᵢ) corresponding to the time (tᵢ) based on the first predicted state of the vehicle comprises:
interpolating the predicted state of the vehicle (PSᵢ) corresponding to the time (tᵢ) based on the first time-stamped data breadcrumb.
